(19) United States
(12) Patent Application Publication
(10) Pub. No.: US 2011/0308093 A1
(43) Pub. Date: Dec. 22, 2011

(54) Label Splitter

(76) Inventors: Jason Stuart Samples, Dallas, GA (US); William Rowlett, Lawrenceville, GA (US)

(21) Appl. No.: 13/118,448

(22) Filed: May 29, 2011

Related U.S. Application Data
(60) Provisional application No. 61/356,407, filed on Jun. 18, 2010.

(51) Int. Cl. B26B 29/00

(52) U.S. Cl. 30/286

(57) ABSTRACT

According to some embodiments, a label splitter comprises a body, and a protective guide. The protective guide is disposed adjacent to the body. The protective guide typically includes a curved lower or bottom surface. The curved lower surface is curved from a first end of the protective guide to a second end of the protective guide. The protective guide is the same width as the body and the body and the protective guide define a therebetween.

### CLAIM OF PRIORITY

This application claims priority to previously filed U.S. Provisional Patent Application Ser. No. 61/356,407 filed on Jun. 18, 2010, the contents of which are incorporated herein in their entirety for all purposes.

### BACKGROUND

A data center has a plurality of cables that connect data equipment such as servers, hubs, routers, and switches. Typically, each cable is labeled so that a network engineer or technician can determine where each end of the cable is connected. Many data centers require frequent re-labeling to maintain accuracy and compliance. With each change, the old label must be removed and the cable must be relabeled with a new label. However, cables, such as fiber optic cables, are fragile and expensive.

Self adhesive labels used for identifying communication, power and network cabling systems are often very difficult to remove. The use of improper tools to remove existing labels often results in sheath or lumen damage, risk to critical hardware, and danger to personnel.

### SUMMARY

According to some embodiments, a label splitter is disclosed. The label splitter comprises a body, and a protective guide. The protective guide is disposed adjacent to the body, and in an embodiment, below the body. The protective guide includes a curved lower or bottom portion. In an embodiment, the curved bottom portion is curved from a first end of the protective guide to a second end of the protective guide. In an embodiment, the protective guide is a same width as the body and the body and the protective guide define a channel therebetween.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 illustrates a side view of a label splitter according to some embodiments.

FIG. 2 illustrates a front view of a label splitter according to some embodiments.

FIG. 3 illustrates a label splitter, a cable and a label media according to some embodiments.

### DETAILED DESCRIPTION

The several embodiments described herein are provided solely for the purpose of illustration. Embodiments may include any currently or hereafter-known versions of the elements described herein. Therefore, persons in the art will recognize from this description that other embodiments may be practiced with various modifications and alterations.

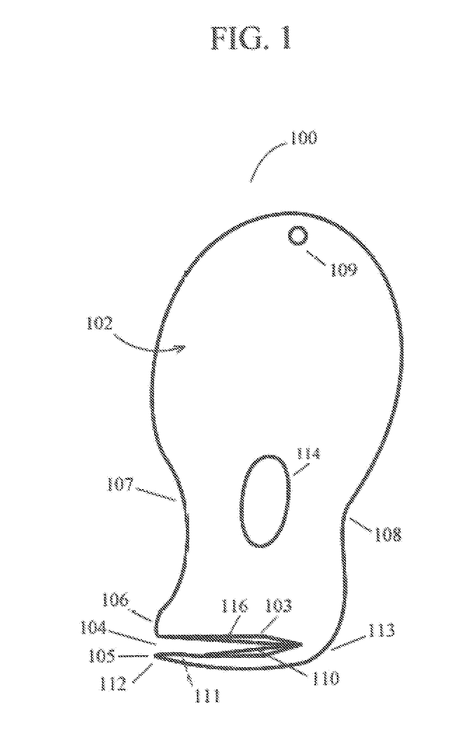

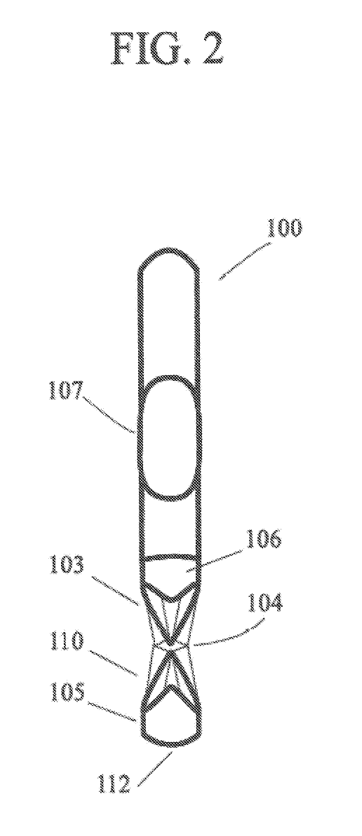

Now referring to FIG. 1 and FIG. 2, an embodiment of a label splitter 100 is illustrated. The label splitter 100 is a tool designed to remove label stock from cables, such as, but not limited to, communication, power and network cabling. The label splitter comprises a body 102, a blade opening 104, and a protective guide 105. The body comprises a first cutting surface 103, a blade guard 106, a front curvature 107, a rear curvature 108, a grip hole 114, and a lanyard hole 109. The protective guide 105 comprises a second cutting surface 110.

The body 102 is configured and designed to ergonomically accommodate a variety of hand sizes and positions of a user. The body 102 may comprise any hard material supportive of the first and second cutting surfaces 103/110 including, but not limited to, metal, plastic or carbon fibers. In some embodiments, the body 102 may comprise various thicknesses to allow for cutting of thinner or thicker materials depending upon the cutting characteristics desired. In some embodiments the body may be between about 18 and 10 gauge in thickness. In another embodiment, the body is about 14 gauge in thickness.

The cutting surfaces 103/110 comprise any hard material known in the art to hold a sharp edge, including but not limited to metal, plastic or ceramic. The cutting surfaces 103/110 may have various thicknesses or serrations to allow for effective separation of the label media it is intended to cut through. The cutting surfaces 103/110 may be machined out of a material used for the body 102, or may consist of a removable blade.

The blade opening 104 is designed to be wide enough to allow label stock of various thicknesses, lifted by the protective guide 105, to be fed onto the cutting surfaces 103/110. In some embodiments, the protective guide 105 comprises a tapered portion 111 of a top edge of the protective guide 105 to facilitate the lifting of the label stock onto the cutting surfaces 103/110. The tapered portion 111 is disposed between a rounded tip/first end 112 of the protective guide 105 and a second end 113 of the protective guide.

The height of the blade opening 104 may be modified to enhance the ability for the label splitter 100 to easily glide between a label and a cable it is secured to. In some embodiments the blade opening is between about 1/16th and 1 inch in opening height.

The body 102 and the protective guide 105 are integral parts of the label splitter 100. The label splitter 105 is shaped with a rounded tip 112 to protect the sheath of the cable and to not penetrate the lumen. The protective guide 105 is disposed adjacent to the body 102. As shown in the embodiment of FIG. 1, the protective guide 105 is disposed below the body 102. The height and curvatures of the protective guide 105 may have various dimensions to allow it to easily slide beneath a variety of label types and materials. In this manner, the protective guide is curved from the rounded tip 112 to an end 113 of the protective guide 105. The protective guide 105 is substantially a same width as the body 102. Moreover, the body 102 and the protective guide 105 define a channel 116 therebetween. In some embodiments, the channel 116 may be u-shaped or v-shaped. The body 102 comprises a bottom edge that defines a first portion of the channel. Furthermore, the bottom edge comprises a first cutting surface. Likewise, the protective guide 105 comprises a top edge defining a second portion of the channel and the top edge comprises a second cutting surface.

The blade guard 106 provides a protective rounded shape to prevent the accidental puncture or damage of any surrounding equipment or materials should the label splitter 100, as might happen if the hand of the user slipped for instance, suddenly lose contact with the desired cutting medium (e.g. a label).

The front curvature 107, and rear curvature 108, allows a user's hand to easily and comfortably grasp the label splitter 100 while accommodating the tool both in a pulling or pushing motion while cutting in either the left or right hand.

The lanyard hole 109, and or grip hole 114, may be located anywhere within the body 102, to allow for an improved grip or for the attachment of other related tools or to retain the label splitter using a simple ring or lanyard cord for convenience.

The present embodiments may include additional beneficial features. The label splitter 100 may benefit from an attachment of a light source to facilitate the work of removal of a label in a dimly lit location, or a pocket clip such that a tool could be attached to a user's clothing for convenience. The label splitter 100 may comprise a non-slip coating or a variety of textures or holes in or along the body 102 to improve a user's ability to grip the label splitter 100.

In another embodiment, the body 102 may comprise a removable or replaceable blade system that allows a commonly used razor blade to be quickly installed or removed to ensure a sharpened cutting edge at all times. In yet another embodiment, two bodies 102 may be used to sandwich a replaceable blade. Additionally, the body 102 of the label splitter 100 may be thickened or shaped to allow for more comfort to the user's hand and/or to accommodate a replaceable blade holder. The body 102 may be stamped or cut out of various gauges of sheet materials and the cutting surfaces 103/110 may be machined or cut to various angles to a razor sharp edge.

The label splitter 100 comprises cutting surfaces 103/110 that are an integral part of the body 102 and are preferably machined out of the same material of which the body 102 is comprised so that, the cutting surfaces 103/110 can be sharpened as needed if they become dull.

If replaceable cutting surfaces 103/110 are used, connections to couple the replaceable cutting surfaces to the body 102 may include any known connectors, including screws, bolts, adhesives, etc. (not shown).

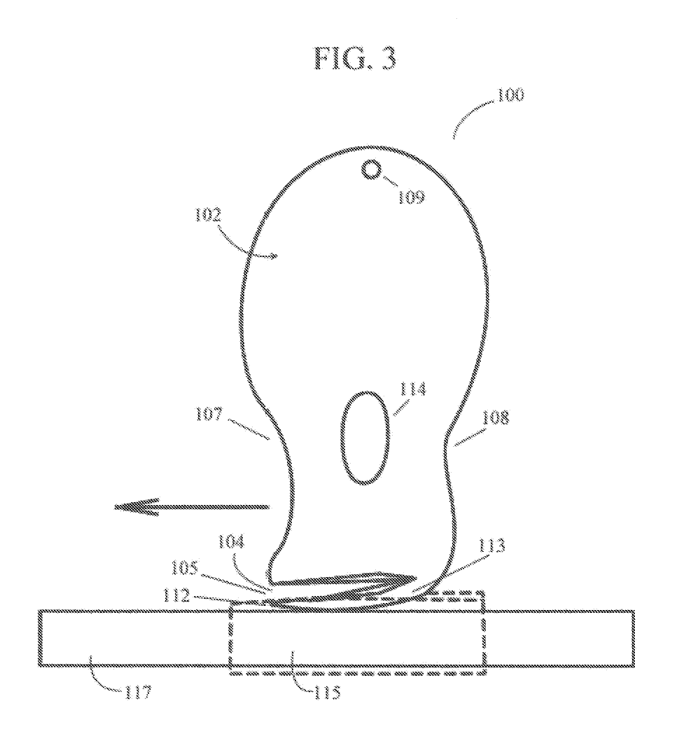

Now referring to FIG. 3, the label splitter 100 may to be grasped around the body 102 by fingers of a right or left hand using the front and rear curvatures 107/108, respectively, such that the protective guide 105 can be slid between the sheath of the cable 117 and under the label media 115 that is wrapped around it. As the protective guide 105 slides beneath the label media 115, one or more of the cutting surfaces 103/110 splits the media, separating it as the body 102 is pushed or pulled along the length of the cable sheath 117.

Once the protective guide 105 has slid beneath the length of the label media 115, the label media 115 will be cut, making it easy to peel off all layers of the label media 115 as a single unit for disposal without damage to the cable sheath. The blade guard 106 provides a protective rounded shape to prevent the accidental puncture or damage of any surrounding equipment or materials should the label splitter 100 lose contact with the desired cutting medium suddenly. As illustrated, the blade guard 106 is at least as wide as the protective guide 105.

The several embodiments described herein are solely for the purpose of illustration. Persons skilled in the art will recognize from this description that other embodiments may be practiced with modifications and alterations limited only by the claims.

What is claimed is:

1. A label splitter, comprising:
a body, and
a protective guide disposed adjacent to the body, the protective guide comprising a lower portion being curved from a first end of the protective guide to a second end of the protective guide,
wherein the protective guide is a same width as the body, and
wherein the body and the protective guide define a channel therebetween.

2. The label splitter of claim 1, wherein the body comprises:
a bottom edge defining a first portion of the u-shaped channel, the bottom edge comprising a first cutting surface.

3. The label splitter of claim 2, wherein the protective guide comprises:
a top edge defining a second portion of the u-shaped channel, the top edge comprising a second cutting surface.

4. The label splitter of claim 3, wherein the protective guide further comprises:
a tapered portion of the top edge, the tapered portion disposed between the first end and the second cutting surface.

5. The label splitter of claim 4, wherein the first end is rounded.

6. The label splitter of claim 1, wherein the body comprises a lanyard hole.

7. The label splitter of claim 1, wherein the body comprises a front curvature potion and a rear curvature portion.

8. The label splitter of claim 1, further comprising an opening between the body and the protective guide.

9. The label splitter of claim 1, wherein the channel is u-shaped.

10. The label splitter of claim 1, wherein the channel is v-shaped.

11. A label splitter, comprising:
a body; and
a protective guide disposed below the body, the body and the protective guide defining a channel therebetween,
wherein the body comprises:
a bottom edge defining a first portion of the channel, the bottom edge comprising a first cutting surface, and
wherein the protective guide comprises:
a top edge defining a second portion of the channel, the top edge comprising a second cutting surface,
a bottom portion curved from a first end of the protective guide to a second end of the protective guide, and
a tapered portion of the top edge, the tapered portion disposed between the front end and the second cutting surface, wherein the protective guide is a same width as the body.

12. The label splitter of claim 11, wherein the first end is rounded.

13. The label splitter of claim 11, wherein the body comprises a front curvature potion and a rear curvature portion.

14. The label splitter of claim 11, further comprising an opening between the body and the protective guide.

15. The label splitter of claim 11, wherein the channel is u-shaped.

16. The label splitter of claim 11, wherein the channel is v-shaped.
